(19) United States
(12) Patent Application Publication
(10) Pub. No.: US 2019/0236847 A1
(43) Pub. Date: Aug. 1, 2019

(54) METHOD AND SYSTEM FOR ALIGNING DIGITAL DISPLAY OF IMAGES ON AUGMENTED REALITY GLASSES WITH PHYSICAL SURROUNDS

(71) Applicant: Red Crater Global Limited, Cambridge (NZ)

(72) Inventor: Peter Neil, Cambridge (NZ)

(21) Appl. No.: 15/885,060

(22) Filed: Jan. 31, 2018

(51) Int. Cl. G06T 19/20; G06T 19/00; G06T 7/30; G06T 7/50

(52) U.S. Cl. CPC G06T 19/20; G06T 19/006; G06T 2219/2016; G06T 7/50; G06T 2219/2004; G06T 7/30

(57) ABSTRACT

A method and system of a wearer (2) aligning digital display of images of a three-dimensional model (1) on augmented reality glasses (3) with physical surrounds (10). The three-dimensional digital model (1) of physical surrounds (10) is generated and distinct first (A) and second reference (B) points in the physical surrounds selected. The location of the first (A) and second (B) reference points is determined on the three-dimensional digital model (1) and a corresponding image of the three-dimensional model (1) is displayed on the augmented reality glasses (3). The location of the three-dimensional model (1) is translated so that the distance between the second reference point (B) of the three-dimensional model (1) substantially corresponds in space to the second reference point (B) in the physical surrounds. The corresponding image of the three-dimensional model (1) displayed on the augmented reality glasses (3) is then rotated so that the distance between the first reference point (A) of the three-dimensional model and the first reference point (A) of the physical surrounds is minimized within a predetermined distance and/or angle so as to align the images of the three-dimensional model (1) with the physical surrounds.

### FIELD OF THE INVENTION

The invention relates to augmented reality glasses and, in particular, to a method of aligning digital images projected onto or produced by an ocular device.

The invention has been developed primarily for use with spectacle-type augmented reality devices such as Microsoft HoloLens™ glasses for aligning digital images produced thereby with the field of view of the wearer of those glasses and will be described hereinafter with reference to this application. However, it will be appreciated that the invention is not limited to Microsoft HoloLens™ glasses and is applicable to other types of glasses or oculars.

### BACKGROUND ART

Augmented reality glasses are typically spectacle-type devices that resemble conventional spectacles or goggles as having a lens covering their eyes and supported over the ears by a pair of arms and by the nose on a bridge. Computer controlled information and images are able to be displayed to the user such as by projection means or waveguides. The difference being augmented reality glasses include or are attached to a computing device to display information alongside or over the top of the field of view of the wearer. Non-spectacle-type augmented reality devices include automobile-type heads up display systems, for example, which project an image such as current speed or the like onto the field of view of the windscreen of a driver.

The information displayed in augmented reality devices can be any desired and can correspond to objects seen by, the wearer. The augmented information can correspond to sensor input such as eye tracking of a wearer or spatial orientation of the glasses to orient a display to correspond to a field of view of the wearer of the glasses. This way, images or information is displayed corresponding to what a user sees. Further, information relayed or input by the wearer to augmented reality glasses computing device can be provided by push buttons on a touch screens, voice control, eye tracking or user gesture control of the wearer, for example. In the case of the Microsoft HoloLens™ augmented reality glasses, inputs include user gesture or voice input.

Use of augmented reality glasses is becoming well known. One older example of this is weapons system data relayed to pilots of Apache helicopters via a helmet mounted display. The eye of the wearer is followed by an eye tracking device and weapons are aligned correspondingly with movement of the wearer's eye movement and corresponding targeting information is displayed on the helmet field of view. This advantageously frees a user to pilot the helicopter and not need to be aiming weapon systems and where the alignment of the weapon system need not correspond to the orientation of the helicopter. In the case of the Apache helicopter displays, these overlap a single ocular with infrared images from a front mounted thermographic camera. That cameral is moved corresponding to the orientation of the wearer's eye direction.

Use of augmented reality glasses is also being heavily researched for various purposes. These include medical procedures whether surgical or not, or other technological uses to allow a user to have presented in front of them a model or such a model of an image projected into the field of view.

For example, a medical model projected into the field of view of a surgeon that is overlayed onto and remains tracked to an actual patient. One example of such is the use of a system where reference markers are disposed in fixed positions that are exactly known. In the case where an overlay digital model is used, it is well known that the model projected on the augmented reality glasses has a tendency to drift, or otherwise lose alignment. A user can simply re-reference the orientation of the augmented reality glasses to the physical location of known fixed markers to realign the projected image model, or other information. This is known to be quite accurate and reliable, however, it requires physical markers to be in fixed locations to allow recalibration of the image provided by the augmented reality glasses. In the case where a wearer moves to a location not being in a line of sight with the fixed markers, this known technique of alignment between the augmented reality glasses and the field of view seen by the wearer is not possible.

In a specific implementation of augmented reality in surgical applications, Suenaga et al, BMC Medical Imaging (2015) 15:51, discloses a marker-less registration system using stereo vision cameras in maxillofacial surgery. In this implementation, a stereo camera is employed for tracking an image registration or alignment without the use of external physical fixed markers but pointes on the patient are defined to be such markers. A three dimensional model of the jaw of a patient was created and an overlay of an image of the model is displayed in real space.

This system employs a determination of characteristic points of the patient's features using parallax images from a pair of stereoscopic cameras. The stereoscopic cameras are mounted adjacent the eyes of the surgeon and the augmented reality image is projected onto a half silvered mirror where it is overlayed with the actual view seen by the surgeon through the mirror.

Suenaga et al refer to the usual implementation of fixed external anatomical landmarks (ie markers) on a patient for image registration with the augmented reality image. In the maxillofacial surgery, this is improved by using the incisal margins of the patient being tracked with the stereoscopic cameras. In this way, corresponding feature points of the projected digital model and the patient were matched to provide registration or alignment.

The system of Suenaga et al requires relatively expensive and spatially bulky apparatus and the accurate placement of the generated model of the patient is essential. Further, both the patient and the practitioner are required to remain in substantially a single location because of the use of the fixed half silvered mirror through which the practitioner observes. This also has limitations in preventing the method of that disclosure from being employed in conventional spectacle type augmented reality glasses such as the Microsoft HoloLens™.

A more mobile solution is provided in the disclosure of Wang et al in Nature, Scientific Reports 7, Article No:433(217). This disclosure provides a method of aligning or registering an image projected by the augmented reality glasses with the environment as seen through the glasses by a user. The glasses implementing the system employ a pair of liquid crystal display lenses together with a pair of optical beam splitters. Wang et al aimed to solve three problems with augmented reality namely, the alignment or registration of displayed images with the field of view of the wearer; vision correction for deaf of field; and improved contrast via light variability. Wang et al observed that the plane of focus of a projected virtual image in augmented reality glasses may not necessarily coincide with that of a the physical object being observed resulting in a misalignment of images. That disclosure provides the use of liquid crystal on silicone displays where polarisation dependence of the liquid crystal element are removed.

Here, liquid crystal lenses having a continuously tuneable lensing power are provided and the location of the projected image is electrically tuneable using the liquid crystal display lens. In this way, an image is aligned or registered with the image displayed by the augmented reality glasses.

Whilst Wang et al addressed image registration of the field of view of the wearer of the augmented reality glasses and the projected digital image, relatively sophisticated and precise optical components are required with a relatively high degree of precision in their alignment in order to address image registration. Importantly, the system of Wang requires tuneable focussing lenses and is not directly implementable across different types of augmented reality glasses which are plain or fixed focus as the specialised display is required in that system.

Known techniques for aligning or registering images produced on augmented reality glasses with the field of view seen by the wearer typically requires specialised equipment that needs relatively precise alignment to achieve a result. Furthermore, many methods and systems include apparatus that is too bulky or unable to be used in a mobile environment without the use of fixed alignment or registration markers.

### Genesis of the Invention

The genesis of the present invention is a desire to provide a simplified method and system for aligning the digital display of image on augmented reality glasses with the field of view seen by a wearer, or to provide a useful alternative.

### SUMMARY OF THE INVENTION

In accordance with a first aspect of the present invention there is disclosed a method of aligning digital display of images of a three-dimensional model on augmented reality glasses with physical surrounds, the method comprising the steps of:
generating a three-dimensional digital model of physical surrounds;
selecting a first reference point in the physical surrounds;
selecting a second reference point spaced apart from the first in the physical surrounds;
determining corresponding first and second reference points on the three-dimensional digital model;
displaying a corresponding image of the three-dimensional model on the augmented reality glasses and translating the location of the three-dimensional model so that the distance between the second reference point of the three-dimensional model and the substantially corresponds in space to the second reference point in the physical surrounds; and
rotating the corresponding image of the three-dimensional model displayed on the augmented reality glasses so that the distance between the first reference point of the three-dimensional model and the first reference point of the physical surrounds is minimised within a predetermined distance and/or angle so as to align the images of the three-dimensional model with the physical surrounds.

In accordance with a second aspect of the present invention there is disclosed a method of aligning digital display of images of a three-dimensional model on augmented reality glasses with physical surrounds defined by two or more delineated regions, the method comprising the steps of:
generating a three-dimensional digital model of the first region of the physical surrounds and generating a three-dimensional digital model of the second region of the digital surrounds;
selecting a first reference point in the first region of the physical surrounds;
selecting a second reference point spaced apart from the first reference point in the first region of the physical surrounds;
determining corresponding first and second reference points on the three-dimensional digital model for the first region of the physical surrounds;
selecting a first reference point in the second region of the physical surrounds;
selecting a second reference point spaced apart from the first reference point in the second region of the physical surrounds;
determining corresponding first and second reference points on the three-dimensional digital model of the second region of the physical surrounds;
determining the region in which the augmented reality glasses are located;
displaying a corresponding image of the three-dimensional model on the augmented reality glasses and translating the location of the three-dimensional model so that the distance between the second reference point of the three-dimensional model and the second reference point in the region of the physical surrounds is minimised; and
rotating the corresponding image of the three-dimensional model displayed on the augmented reality glasses so that the distance from the first reference point of the three-dimensional model and the first reference point of the region of the physical surrounds is minimised within a predetermined distance and/or so as to align the images of the three-dimensional model with the region of the physical surrounds.

In accordance with another aspect of the present invention there is disclosed a method of aligning digital display of images of a three-dimensional model on augmented reality glasses with physical surrounds having two or more access points thereto, the method comprising the steps of :
generating a three-dimensional model of the physical surrounds;
selecting a first reference point in the physical surrounds relative to a first access point of the physical surrounds;
selecting a second reference point in the physical surrounds relative to the first access point of the physical surrounds, the second reference point being spaced apart from the first reference point;
determining corresponding first and second reference points on the three-dimensional digital model relative to the first access point of the physical surrounds;
selecting a first reference point in the physical surrounds relative to a second access point of the physical surrounds;
selecting a second reference point in the physical surrounds relative to the second access point of the physical surrounds, the second reference point being spaced apart from the first reference point;
determining corresponding first and second reference points on the three-dimensional digital model relative to the second access point of the physical surrounds;
determining by the location of the augmented reality glasses relative to the first or second access points of the physical surrounds;
displaying an image of the three-dimensional model on the augmented reality glasses in response to the determined location of the augmented reality glasses relative to the first or second access points of the physical surrounds and translating the location of the three-dimensional model so that the distance between the second reference point of the three-dimensional model and the second reference point of the physical surrounds is minimised; and
rotating the corresponding image of the three-dimensional model displayed on the augmented reality glasses so that the distance from the first reference point of the three-dimensional model and the first reference point of the physical surrounds is minimised within a predetermined distance and/or so as to align the images of the three-dimensional model with the physical surrounds.

It can therefore be seen that there is advantageously provided a simplified method of aligning images projected onto the field of view of a wearer of augmented reality glasses with surrounds seen by the wearer without the need for fixed markers and using conventional augmented reality glasses such as Microsoft HoloLens™. Furthermore, it will be appreciated that the method is able to relatively simply realign the digital model with any “drift” between that and the physical surround. Also the method is not limited to specific augmented reality display types and is useful across a plurality of different types of augmented reality glasses.

### BRIEF DESCRIPTION OF THE DRAWINGS

Preferred embodiment of the invention will now be described, by way of example only, with reference to the accompanying drawings in which:

FIG. 1 is a flowchart representation of a method of aligning a virtual reality image with the environment of a wearer;

FIG. 2 is a schematic representation indicating spatial inaccuracies of an augmented reality display image with a corresponding real world object in the method of FIG. 1;

FIG. 3 is a schematic representation of a user wearing augmented reality glasses selecting reference points for alignment of the augmented reality image display;

FIG. 4 is a schematic representation of the method of FIG. 1 in moving the augmented reality image displayed to align with the surrounds of a wearer;

FIG. 5 is a schematic plan view of the physical environment of FIGS. 2-4;

FIG. 6 is a schematic plan view of a physical environment having a pair of access points;

FIG. 7 is a schematic plan view of a physical environment having a plurality of rooms;

FIG. 8 is a schematic representation of a system for finding the digital display of images of a three-dimensional model and augmented reality glasses; and

FIG. 9 is a flowchart of the process of using the system of FIG. 8.

### DETAILED DESCRIPTION

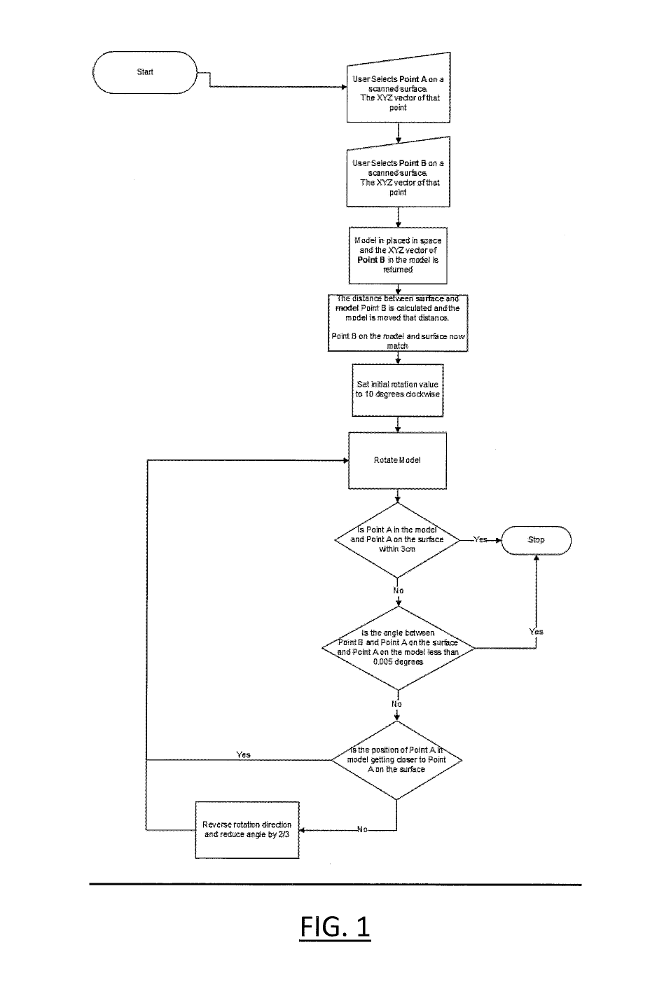

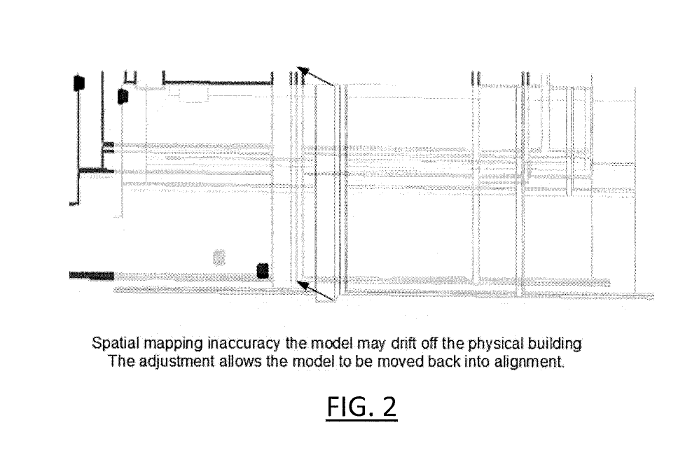

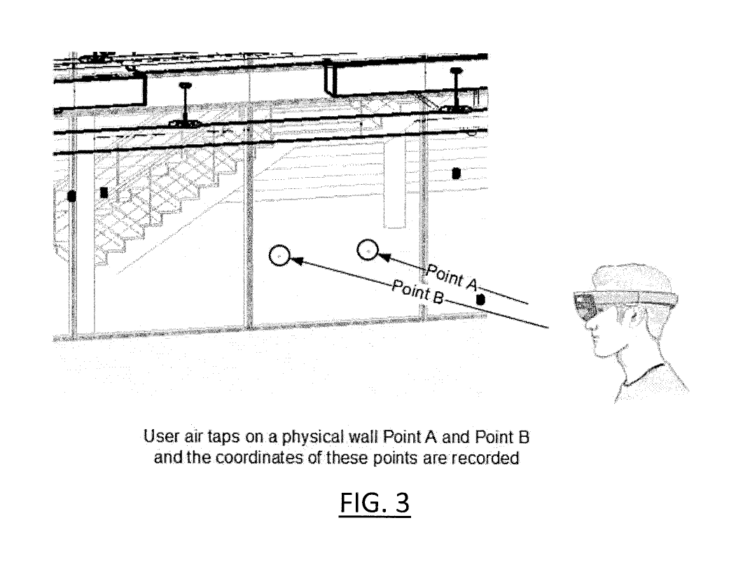

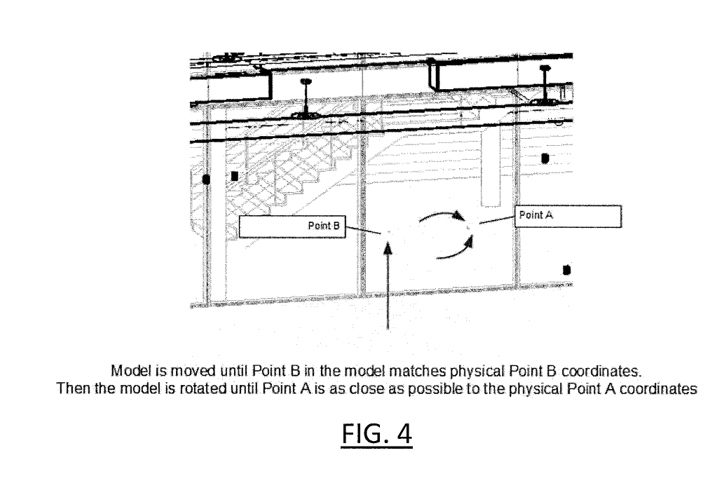

Referring to the drawings, FIG. 1 is a flowchart showing the steps of the preferred embodiment of the method of aligning a virtual reality image with the environment of a wearer of the virtual reality glasses. FIGS. 2 to 4 are schematic representations of the implementation of the method of the flowchart of FIG. 1.

In the preferred embodiment, alignment of a three-dimensional digital model of physical surrounds is shown with reference to a room 1 in which a user 2 is utilising augmented reality glasses 3 most preferably in the form of Microsoft HoloLens™.

For use with the Microsoft HoloLens™ reality glasses 3, a three-dimensional digital model is generated for the physical surrounds being the room 1 of the preferred embodiment. The three-dimensional model can be created by any preferred means including rendering two-dimensional photographs or images to include depth information; or use of stereoscopic camera images, for example. It will be appreciated also that the three-dimensional digital model of the physical surrounds 1 can be created by computer aided design software, such as Autodesk AutoCAD™ or Revit™ or building information modelling (BIM) software as is commonly available. Alternatively, the physical surrounds 1 can be scanned by using a three-dimensional laser scanner.

The three-dimensional digital model is coupled with the augmented reality glasses 3 of the Microsoft HoloLens™. That is, the model is imported to a memory of a computing device 5 controlling display of images on the augmented reality glasses 3 on display 6. The computing device 5 also receives input from sensor on the glasses or input directly from the wearer.

In the case of using the Microsoft HoloLens™ augmented reality glasses 3, in the preferred embodiments, data can be input 8 by the wearer such as by voice or hand gesture, or by wireless connection from a computing device 5 such as a general purpose computer or smartphone. The Microsoft HoloLens™ augmented reality glasses 3 include sensors 7 to determine changes in orientation of the glasses 3 which, generally speaking, allows the computing device 5 to determine the direction a wearer 2 is looking and their field of view of their physical surrounds 1.

It is by this mechanism that the computing device 5 of the glasses 3 is configured to receive the three-dimensional digital model of the physical surrounds 1 of the computer for display on the Microsoft HoloLens™ augmented reality glasses 3. Sensed changes in the orientation of the glasses 3 cause the computing device 5 thereof to project an image of the three-dimensional digital model that corresponds to the field of view of the wearer 2 through the glasses 3.

Whilst using the augmented reality glasses 3, the user 2 selects a first and a second reference point in the room defining the physical surrounds. In the preferred embodiment, this is shown to be a pair of points on a wall or floor surface 8 denoted point A and point B. The user 2 selects the two points by any preferred input means 8 such as hand gesture control in the preferred embodiment using Microsoft HoloLens™ augmented reality glasses 3.

Once the first and second reference points (denoted A & B in the drawings) have been selected by the user 2, corresponding first and second reference points are identified on the three-dimensional digital model of the room 1.

The corresponding image of the three-dimensional model is then displayed on the display 6 of the augmented reality glasses 3 so as to be overlayed on the physical surrounds 1 seen by the user 2 through the glasses 3. Here, the second reference point in the physical surrounds 1, point B in the drawings, is aligned with the second corresponding reference point in the physical surrounds 1 selected by the user 2 by hand gesture. In this way, the image of the three-dimensional digital model is aligned to a single point in the physical surrounds 1.

With the distance between the second reference point B of the three-dimensional digital model and the second reference point of the physical surrounds 1 in the view of the user 2 of the virtual reality glasses 3 minimised, the image presented to the user 2 is then rotated about the second reference point B until the distance between the first reference point A of the three-dimensional digital model and the first reference point A in the physical surrounds 1 selected by the user is minimised. In this way, the distance between the second reference point of the three-dimensional digital model substantially corresponds in space to the second reference point in the physical surrounds.

The alignment of the second reference points B and first reference points A between the three-dimensional digital model and the reference points selected by the user 2 in the physical surrounds 1 thereby aligns the three-dimensional model with those physical surrounds 1. This advantageously provides a relatively simple and straightforward method of aligning the three-dimensional digital model with the real world physical surrounds 1 without the aid of any other reference markers or position sensing equipment. If the alignment of the three-dimensional digital model drifts from alignment with the physical surrounds in the room 1, the above method can simply be repeated.

It is noted that in the preferred embodiment, when the user selects the first and second reference points in the physical surrounds 1, each point is ascribed spatial coordinates, for example, such as in XYZ-coordinates.

In the case of Microsoft HoloLens™ glasses, it will be appreciated that the Microsoft HoloLens™ glasses 3 automatically calibrate the Z-coordinate or vertical direction. The Microsoft HoloLens™ glasses 3 correct for the Z-coordinate so as to be consistent with the surrounding of the glasses 3. Accordingly, in the case of the preferred embodiment using Microsoft HoloLens™ glasses 3 a user only need to consider alignment of the three-dimensional digital model of rotation in the X-Y plain.

Similarly, those same spatial coordinates are ascribed to the first and second selected reference points of the three-dimensional digital model. In this way, translating the location of the second reference point is determined by the computing device 5 in the augmented reality glasses 3 as a linear distance in some direction. The second reference point of the three-dimensional model is then translated that distance and in that direction toward the second selected reference point in the physical surrounds 1 so as to align the second reference points of the three-dimensional model with corresponding reference point of the physical surrounds 1.

In the case of rotating the image of the three-dimensional digital model displayed on the display 6 of the augmented reality glasses 3, it will be understood that if during rotation the distance between first reference point A in the physical surrounds 1 with the corresponding first reference point of the digital model increases, the angle of rotation is reversed and rotation occurs until the first reference points of the physical surrounds 1 and three-dimensional digital model are minimised.

Although in the above description of the preferred embodiment the first and second reference points of the physical surrounds 1 are defined on a surface 9 (ie on a surface 9 in the room 1 of the preferred embodiment). This need not be the case and any point within the room of the preferred embodiment can be selected for the first or second reference points of the physical surrounds 1. However, it is preferred that the first and second reference points of the physical surrounds 1 are on a surface 9 of the room such as a wall, floor or ceiling or could be on an object within the physical surrounds such as a table or other feature.

It is further noted that in the preferred embodiment, user translation of the three-dimensional digital model to align the second reference points can be performed by setting any preferred resolution of movement for the translation. That is, the minimum distance able to be moved during translation of the three-dimensional digital image to align the second reference points can be any desired, for example, 1 cm, 10 cm or any increment that is preferred. This is similarly the case with the step of rotating the three-dimensional digital model so as to align the corresponding first reference points where the increments of rotation can be set at fractions of a degree or radium as desired.

It can therefore be seen that there is advantageously provided in the preferred embodiment a method of aligning the three-dimensional digital model of physical surrounds 1 with the physical surrounds in the field of view of the wearer 2 of augmented reality glasses 3. This is particularly advantageous when the three-dimensional model image projected onto the display 6 of the augmented reality glasses 3 drifts from alignment with the physical surrounds as well as in circumstances when alignment may be lost such as when changing rooms or entering a delineated environment, as described further below. Yet further, it will be appreciated that the method can be applied to any preferred augmented reality glasses 3 or other augmented reality ocular devices such as where the three-dimensional model is projected through or onto a single lens through which the wearer 2 looks with one or both eye. In the case of the preferred embodiment, for example, the Microsoft HoloLens™ augmented reality glasses 3 can execute application software to affect the above described method of the preferred embodiment. Software for achieving such includes Microsoft Visual Basic Studio amongst many others.

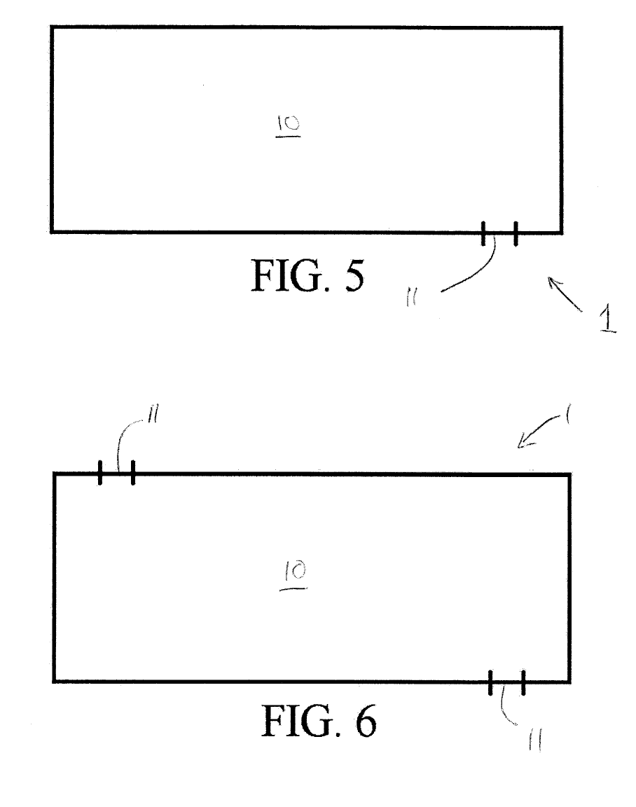

FIG. 5 is a schematic plan view of the physical surrounds in the form of room 1 in FIGS. 2-4. The room 1 defines a region 10 which forms the physical surrounds in the form of room 1 that includes an access way 11. When a user of the virtual reality glasses 3 as above enters the room 1 via the access 11, a computing system of the virtual reality glasses 3 either recognises the location of the wearer 2 of the glasses 3 or has that location input by the wearer of the glasses 3. The generated three-dimensional digital model displayed on the augmented reality glasses 3 is generally aligned for a wearer 2 viewing the room 1 from access 11.

FIG. 6 is a schematic plan view similar to FIG. 5, however, two access points 11 spaced apart from each other are provided for a user 2 to enter the room 1. The three-dimensional digital model of the room 1 is displayed on the virtual reality glasses 3 and depending on which access point 11 is used by a wearer 2, the three-dimensional digital model presented to the wearer is determined depending on which access point 11 is used. In this way, alignment of the three-dimensional digital model can be made from either access point 11 rather than a singular one of those from which alignment can occur. This therefore can be a greater convenience and still provide accuracy in the alignment of the digital model of the physical surround 1.

In the case of an example, where there is a large building being perhaps 100 metres wide by 200 metres long and having two entrances, for example, an east and a west, then first and second reference points A and B in the three-dimensional digital model can be determined where there is one set near the east entrance and one near the west entrance in the example. As such, the user 2 wearing the virtual reality glasses 3 can align the model to the physical surrounds of the room 1 from either entrance 11 rather than forcing the user to enter via one of the entrances.

It can therefore be seen that in practice of the preferred embodiment, that in the case of one entrance to a room the user can align the digital model to the physical surrounds using a pair of reference points in the model corresponding to the physical surrounds 1. If the user enters a room or region from a second entrance, a difference independent set of reference markers A and B reference points can be used. Furthermore, it will be appreciated that if the user moves position from the first entrance or access point to the second entrance of access point they are given a choice of which set of reference markers A and B to allow re-alignment of the digital model with the physical surrounds 1 if necessary. It will be further appreciated that if the digital model projected by Microsoft HoloLens™ glasses 3 drifts from correspondence with the physical surrounds 1, the user can select to use the first set of reference marks A and B corresponding to the first entrance or the second set of reference markers A and B corresponding to the second entrance to allow for re-alignment.

It will further appreciated that in preferred embodiments, the user 2 of the virtual reality glasses 3 may have a plurality of sets of first and second reference points A and B for every room 1 in a property so that the user 2 can align the three-dimensional digital model of the room 1 regardless of which room 1 they start from.

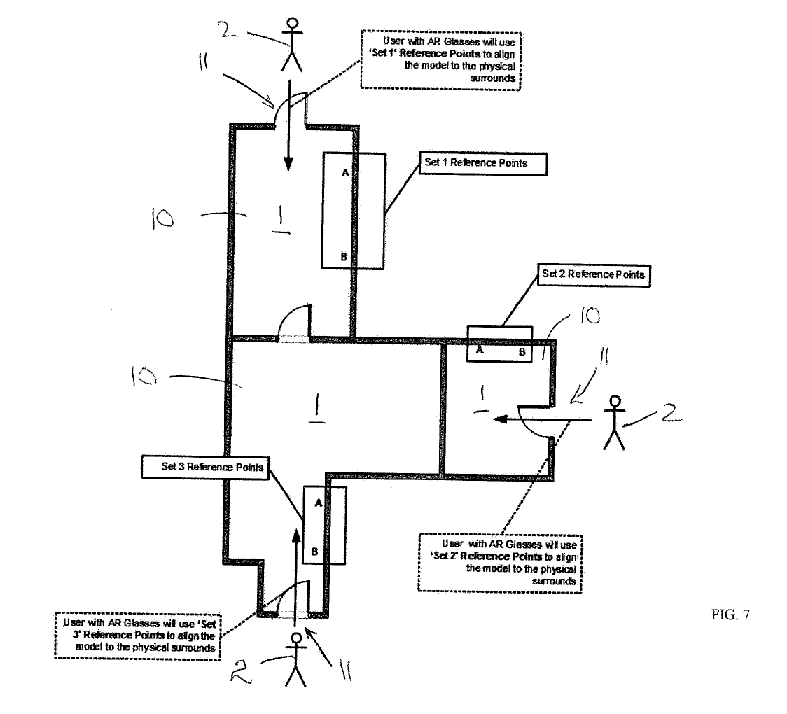

FIG. 7 shows the case of a plurality of regions 10 each in the form of a distinct room 1 and each having at least one entrance 11. The upper and lower rooms 1 each have a plurality of spaced apart access points 11.

The location of the wearer 2 of the virtual reality glasses 3 can be determined by sensors 7 in the glasses or by input 8 from the user. Each room 1 has a set of first and second reference points (A and B) for each access point 11 available to the user 2. Depending on the room 1 entered and via which entrance or access 11, the computing device 5 associated with the virtual reality glasses 3 can project the display of the appropriate three-dimensional digital model of that room 1 from that entrance. The user 2 can then follow the procedure set out regards FIGS. 1-4 to align the three-dimensional digital model with the actual room 1 seen through the glasses 3 by the wearer 2.

Further, the digital model displayed on the Microsoft HoloLens™ glasses 3 in practice could be aligned with a first set of reference markers A and B to display the digital model of the first region on the physical surrounds. If the user to leave the first region and move to the second region, the digital model of the second region can be displayed on the Microsoft HoloLens™ glasses 3 automatically depending on the location thereof as sensed by the glasses 3 or as input by the user and with a second set of reference points A and B, the user in the second region can align the image of the three-dimensional digital model on the glasses 3 with the physical surrounds 1.

In the case where the user moves from the first region to a second region and then back to the first region, the three-dimensional digital model of the first region would be displayed on the glasses 3 for the user. As noted above, this can be by automatically detecting the location of the user and Microsoft HoloLens™ glasses 3 to control which three-dimensional model is displayed or the location of the user can be input by them.

It will be appreciated that in the preferred embodiments of the invention, it is advantageous to configure the Microsoft HoloLens™ augmented reality glasses 3 to allow the image of the three-dimensional digital model being displayed to be shunted or translated about by some relatively fine amount. The translation may be linear or angular. This can accommodate relatively fine misalignments of the images displayed on the digital glasses 3 of the surrounds 1.

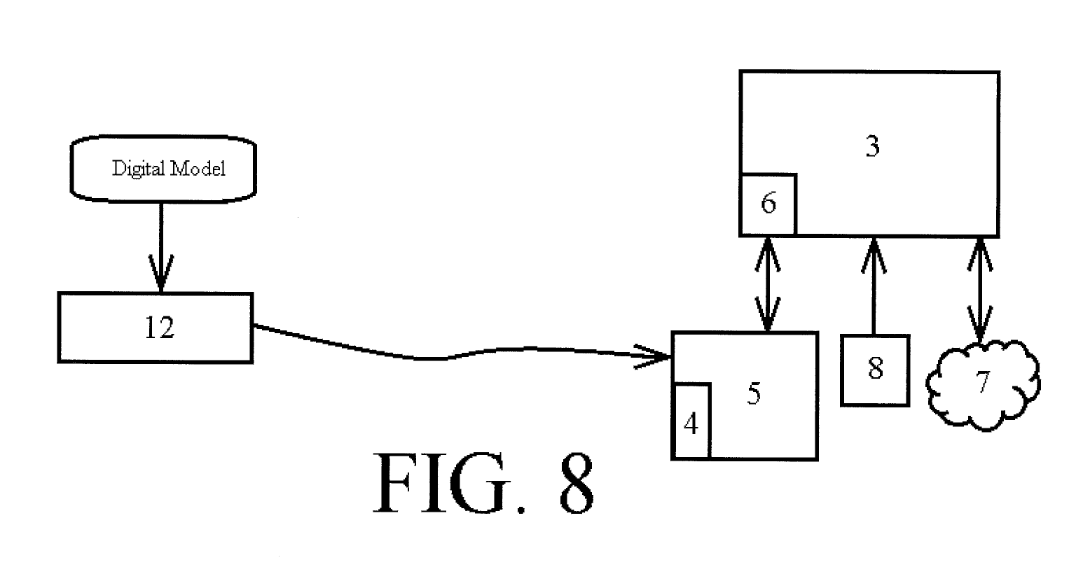

Referring now to FIG. 8, there is shown a schematic representation of a system for effecting the above described method of aligning the digital display of images of a three-dimensional digital model on the augmented reality glasses 3 with physical surrounds 1. In the system, a three-dimensional digital model of the physical surrounds 1 is made on or imported to a computing device 12 remote from the virtual reality glasses 3. The three-dimensional digital model is sent from the remote computer 12 to an associated computing device 5 of the augmented reality glasses 3. The digital model is maintained in a memory 4 of the computing device 5 of the augmented reality glasses 3.

It can be seen that the augmented reality glasses 3 include a user input 8 and have a display 6 for displaying the three-dimensional digital model to the wearer 2. Sensor input 7 to the augmented reality glasses 3 is also provided such as by way of GPS sensors, accelerometers and other orientation sensors, for example. Once loaded into the memory 4 of the computing device 5 of the augmented reality glasses 3, the sensor input 7 to the augmented reality glasses 3 or user input 8 is provided to the associated computing device 5 so as to locate and orient the virtual reality glasses 3. The three-dimensional digital model of the physical surrounds 1 is then displayed on the display 6 of the augmented reality glasses 3 and is aligned as described above with reference to FIGS. 1-4.

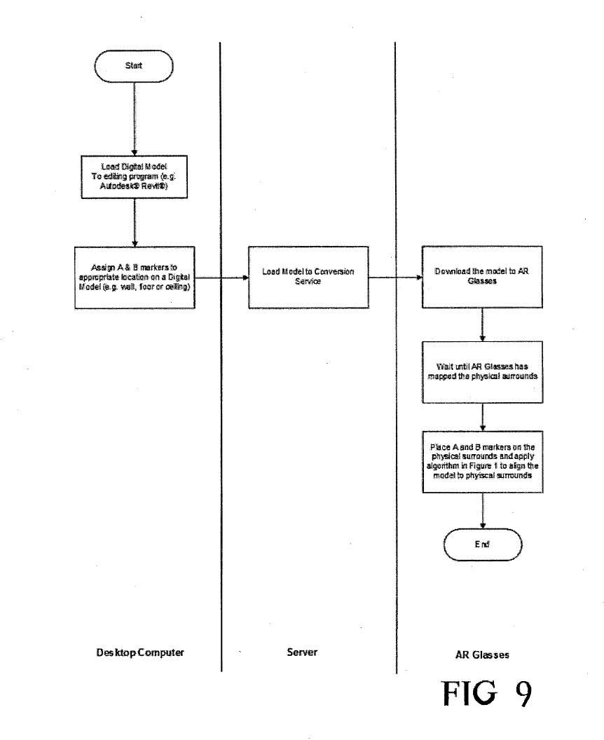

Referring to FIG. 9, a flowchart diagram sets out operation of the system of FIG. 8 in a preferred embodiment. In the flowchart, it is seen that the three-dimensional digital model of the physical surrounds 1 is loaded into the remote computing device 5. This may be produced by the remote computing device 5 and edited such as using Autodesk™ Revit software, for example amongst many others. First and second reference points A and B are assigned to appropriate locations in the digital model most preferably on a wall, floor, ceiling or other surface in the physical surrounds 1. From here, the three-dimensional digital model of the physical surrounds 1 is converted to a format suitable for loading in the computing device 5 of the augmented reality glasses 3.

Once the model is loaded into the virtual reality glasses 3, the augmented reality glasses 3 map the physical surrounds 1 and first and second reference points A and B are defined by the user in the physical surrounds 1. The three-dimensional digital model is then aligned at first and second reference points A and B with those reference points A and B selected by the user in the physical surrounds 1 and the above described method of aligning the digital displayed on the virtual augmented reality glasses 3 is carried out.

The foregoing describes only one embodiment of the present invention and modifications, obvious to those skilled in the art, can be made thereto without departing from the scope of the present invention.

The term “comprising” (and its grammatical variations) as used herein is used in the inclusive sense of “including” or “having” and not in the exclusive sense of “consisting only of”.

1. A method of aligning digital display of images of a three-dimensional model on augmented reality glasses with physical surrounds, the method comprising the steps of:
generating a three-dimensional digital model of physical surrounds;
selecting a first reference point in the physical surrounds;
selecting a second reference point spaced apart from the first in the physical surrounds;
determining corresponding first and second reference points on the three-dimensional digital model;
displaying a corresponding image of the three-dimensional model on the augmented reality glasses and translating the location of the three-dimensional model so that the distance between the second reference point of the three-dimensional model and the substantially corresponds in space to the second reference point in the physical surrounds; and
rotating the corresponding image of the three-dimensional model displayed on the augmented reality glasses so that the distance between the first reference point of the three-dimensional model and the first reference point of the physical surrounds is minimised within a predetermined distance and/or angle so as to align the images of the three-dimensional model with the physical surrounds.

2. A method according to claim 1 wherein spatial coordinates are set for the first and second selected reference points in the physical surrounds and for the corresponding first and second reference points of the three-dimensional model wherein the step of translating the location of the second reference point of the three-dimensional model is determined by calculating the distance between the second reference point of the physical surround and the second reference point of the three-dimensional model.

3. A method according to claim 1 wherein rotating the three-dimensional model further includes the step of reversing a direction of rotation if the distance between the first reference points of the physical surrounds and the three-dimensional model increase with changing angle.

4. A method according to claim 1 wherein the first and second reference points of the physical surrounds are defined on a surface of those physical surrounds.

5. A method according to claim 4 wherein the first and second reference points of the physical surrounds are on a wall, floor, ceiling and/or an object within the physical surrounds.

6. A method according to claim 1 wherein the step of generating a three-dimensional digital model of the physical surrounds includes using a three-dimensional laser scanner; three-dimensional rendering of two-dimensional images or stereoscopic camera images; or a created by computer aided design (CAD) software; or building information modelling (BIM) software.

7. A method according to claim 1 wherein the step of translation and / or rotation of the three-dimensional digital model includes the step of defining a minimum distance of translation or angle of rotation.

8. A method of aligning digital display of images of a three-dimensional model on augmented reality glasses with physical surrounds defined by two or more delineated regions, the method comprising the steps of :
generating a three-dimensional digital model of the first region of the physical surrounds and generating a three-dimensional digital model of the second region of the digital surrounds;
selecting a first reference point in the first region of the physical surrounds;
selecting a second reference point spaced apart from the first reference point in the first region of the physical surrounds;
determining corresponding first and second reference points on the three-dimensional digital model for the first region of the physical surrounds;
selecting a first reference point in the second region of the physical surrounds;
selecting a second reference point spaced apart from the first reference point in the second region of the physical surrounds;
determining corresponding first and second reference points on the three-dimensional digital model of the second region of the physical surrounds;
determining the region in which the augmented reality glasses are located;
displaying a corresponding image of the three-dimensional model on the augmented reality glasses and translating the location of the three-dimensional model so that the distance between the second reference point of the three-dimensional model and the second reference point in the region of the physical surrounds is minimised; and
rotating the corresponding image of the three-dimensional model displayed on the augmented reality glasses so that the distance from the first reference point of the three-dimensional model and the first reference point of the region of the physical surrounds is minimised within a predetermined distance and/or so as to align the images of the three-dimensional model with the region of the physical surrounds.

9. A method according to claim 8 wherein spatial coordinates are set for the first and second selected reference points in each region in the physical surrounds and for the corresponding first and second reference points of the three-dimensional model wherein the step of translating the location of the second reference point of the three-dimensional model is determined by calculating the distance between the second reference point in the region of the physical surrounds and the second reference point of the three-dimensional model.

10. A method according to claim 8 wherein rotating the three-dimensional model further includes the step of reversing a direction of rotation if the distance between the first reference points of the physical surrounds and the three-dimensional model increase with changing angle.

11. A method according to claim 8 wherein the first and second reference points of each region of the physical surrounds are defined on a surface of those physical surrounds.

12. A method according to claim 11 wherein the first and second reference points of each region of the physical surrounds are on a wall, floor, ceiling and/or an object within the physical surrounds.

13. A method according to claim 8 wherein the step of generating a three-dimensional digital model of the physical surrounds includes using a three-dimensional laser scanner; three-dimensional rendering of two-dimensional images or stereoscopic camera images; or a created by computer aided design (CAD) software; or building information modelling (BIM) software.

14. A method according to claim 8 wherein the step of translation and/or rotation of the three-dimensional digital model includes the step of defining a minimum distance of translation or minimum will exclude angle of rotation.

15. A method of aligning digital display of images of a three-dimensional model on augmented reality glasses with physical surrounds having two or more access points thereto, the method comprising the steps of :
generating a three-dimensional model of the physical surrounds;
selecting a first reference point in the physical surrounds relative to a first access point of the physical surrounds;
selecting a second reference point in the physical surrounds relative to the first access point of the physical surrounds, the second reference point being spaced apart from the first reference point;
determining corresponding first and second reference points on the three-dimensional digital model relative to the first access point of the physical surrounds;
selecting a first reference point in the physical surrounds relative to a second access point of the physical surrounds;
selecting a second reference point in the physical surrounds relative to the second access point of the physical surrounds, the second reference point being spaced apart from the first reference point;
determining corresponding first and second reference points on the three-dimensional digital model relative to the second access point of the physical surrounds;
determining by the location of the augmented reality glasses relative to the first or second access points of the physical surrounds;
displaying an image of the three-dimensional model on the augmented reality glasses in response to the determined location of the augmented reality glasses relative to the first or second access points of the physical surrounds and translating the location of the three-dimensional model so that the distance between the second reference point of the three-dimensional model and the second reference point of the physical surrounds is minimised; and
rotating the corresponding image of the three-dimensional model displayed on the augmented reality glasses so that the distance from the first reference point of the three-dimensional model and the first reference point of the physical surrounds is minimised within a predetermined distance and/or so as to align the images of the three-dimensional model with the physical surrounds.

16. A method according to claim 15 wherein spatial coordinates are set for the first and second selected reference points from each access point in the physical surrounds and for the corresponding first and second reference points of the three-dimensional model wherein the step of translating the location of the second reference point of the three-dimensional model is determined by calculating the distance between the second reference point in the region of the physical surrounds and the second reference point of the three-dimensional model.

17. A method according to claim 15 wherein rotating the three-dimensional model further includes the step of reversing a direction of rotation if the distance between the first reference points of the physical surrounds and the three-dimensional model increase with changing angle.

18. A method according to claim 15 wherein the first and second reference points of each region of the physical surrounds are defined on a surface of those physical surrounds.

19. A method according to claim 18 wherein the first and second reference points relative to each access point of the physical surrounds are on a wall, floor, ceiling and/or an object within the physical surrounds.

20. A method according to claim 15 wherein the step of generating a three-dimensional digital model of the physical surrounds includes using a three-dimensional laser scanner; three-dimensional rendering of two-dimensional images or stereoscopic camera images; or a created by computer aided design (CAD) software; or building information modelling (BIM) software.

21. A method according to claim 15 wherein the step of translation and/or rotation of the three-dimensional digital model includes the step of defining a minimum distance of translation or minimum will exclude angle of rotation.
